(19) United States
(12) Patent Application Publication
(10) Pub. No.: US 2005/0033558 A1
(43) Pub. Date: Feb. 10, 2005

(54) Method for monitoring a technical system

(76) Inventor: Gerit Edler von Schwertfuehrer, Ludwigsburg (DE)

Correspondence Address: KENYON & KENYON, ONE BROADWAY, NEW YORK, NY, 10004, US

(21) Appl. No.: 10/885,215

(22) Filed: Jul. 6, 2004

(30) Foreign Application Priority Data
Jul. 14, 2003 (DE) 103 31 872.0

(51) Int. Cl. G06F 11/00

(52) U.S. Cl. 702/188

(57) ABSTRACT

A method for monitoring and/or regulating an technical system, in particular of a vehicle, having at least two control units interconnected via a bus system, which have at least one computing element each and which perform monitoring-relevant control procedures and monitoring procedures, a trans-controller software frame, which is implementable on the control unit, in particular in the computing element of the control unit, which monitors and/or regulates the user software of the control unit.

### FIELD OF THE INVENTION

The present invention relates to a method for monitoring a technical system.

### DESCRIPTION OF RELATED ART

There are different concepts for designing a control unit to be error-free or intrinsically safe. Known ESP/ABS control units in vehicles, for example, currently perform monitoring using the two-computer method, the function software being computed simultaneously on a second, mostly identical computer and the results of both computers being compared. This method is known to be intrinsically safe; it is, however, expensive due to the use of two computers.

A more advantageous option for achieving intrinsic safety of a control unit is monitoring using the three-level method, the second computer being replaced by a more advantageous monitoring module.

German Patent No. 44 38 714 describes a method and a device for controlling a propulsion unit of a vehicle. Here the control unit has only a single computing element, known as a microcomputer, for performance control. The computing element performs both control and monitoring. Operational safety and availability are ensured by the fact that at least two independent levels, which are independent of one another at least in the absence of errors, are provided in a single computing element (microcomputer), the functions for performance control being computed in a first level, and these functions and thus the reliability performance of the computing element itself being monitored, optionally in cooperation with a monitoring module (watchdog), in a second level. Furthermore, German Patent No. 44 38 714 describes a third level, which performs sequence control of the second level. This monitoring by the third level considerably enhances operational safety and availability. The use of a monitoring module (watchdog), which performs sequence control as a question-answer game, is known.

Today's engine control units in vehicles monitor electronic volumetric control systems (EVC/EGAS) using the three-level method. The engine control unit here includes a function computer and the monitoring module (watchdog). The function computer and the monitoring module communicate via question-answer communication and have separate shut-off paths. Level 1 is the actual function software, which is required for operating the engine. Level 1 is executed on the function computer. In level 2, which is also executed on the function computer, a permissible torque is compared with an actual engine torque based on a simplified engine model. This level is executed in a hardware area secured by level 3. Components of level 3 include the instruction test, the program sequence control, the A/D converter test, as well as cyclic and complete memory tests. In current electronic volumetric control systems, the entire function and monitoring software is located in a single control unit.

In a system, for example in a vehicle, both types of control units are often present. The control units operate mostly independently of one another. An error recognized by one control unit results in an error response by the same control unit.

The disadvantage is that the individual control units cannot be connected in any desired way. This means that it is not possible for an error recognized by a first control unit to result in an error response in another control unit.

With the increasing number of control units, in particular in vehicles, the need increases for trans-controller software for smart, overall regulation, control, and monitoring of different systems.

### SUMMARY OF THE INVENTION

It is an object of the invention to create a trans-controller monitoring concept to which all control units of a system are connectable to allow optimum, simple, and cost-effective monitoring and regulation of the overall system. Furthermore, the present invention is to make it possible for error recognition and the subsequent error response to take place on different control units.

These and other objects of the invention are achieved by a method for monitoring and/or regulating a technical system, in particular a vehicle, having at least two control units interconnected via a bus system, which have at least one computing element each and which perform monitoring-relevant control procedures and monitoring procedures, wherein a trans-controller software frame, which is implemented in the control units, in particular in the computing elements of the control units, monitors and/or regulates the user software (15) of the control unit. Through the measure according to the present invention to carry out the monitoring and/or the regulation of the user software of the control unit via a trans-controller software frame, which is implemented in the control units, in particular in the computing elements of the control units which perform monitoring-relevant control procedures and monitoring procedures, a monitoring concept is created, to which all control units of a system are connectable. Optimum, simple, and cost-effective monitoring and regulation of the overall system is thus made possible.

### BRIEF DESCRIPTION OF THE DRAWINGS

The present invention will be described in greater detail with reference to the following drawings wherein:

FIG. 1 shows a schematic representation of the trans-controller software frame, illustrating individual method steps.

FIG. 2 shows a monitoring concept according to the present invention for a vehicle having three control units.

### DETAILED DESCRIPTION OF THE INVENTION

It is advantageous if, after the implementation of the trans-controller software frame, at least two independent levels are provided in the computing element of a control unit, a first level performing the control function and a second level performing the monitoring function. This separation of control function, i.e., user software and monitoring function, makes it possible to design each control unit single-error safe and intrinsically safe. The first level, i.e., performance control of the control unit, is present in all control units. Due to the implementation of the trans-controller software frame, this first level is monitored by a second level, which is a component of the software frame.

It is furthermore advantageous if a third level of the trans-controller software frame checks the operation of the computing element by monitoring the level which performs the monitoring. The third level is also a component of the software frame and, together with the second level and the function software, i.e., user software of the first level, forms the monitoring concept. The three-level concept may thus be implemented in an overall system having a plurality of control units.

The use of a trans-controller software frame makes a uniform monitoring concept for an overall system including a plurality of control units possible. The overall system is advantageously monitored using a three-level concept, as is known in the case of individual control units. In contrast to monitoring a single control unit, overall monitoring offers the option to freely distribute functions, i.e., software to control units without loss of monitoring quality or error response capability.

The present invention permits error recognition to be separated from error response. This means that a component error may be recognized by a first control unit and result in an error response in another control unit. The error response may be generalized to different requirements, such as, for example, no further acceleration, no brake intervention, or no further engine speed increase.

Another advantageous method step is if at least one monitoring module, known as a level 2 module, which is exchangeably connected to the second level of the trans-controller software frame, tests the instruction set of the computing element's central processing unit (CPU) used by the same monitoring module. Function monitoring, including modular program sequence control and modular instruction test, is performed here.

The monitoring module tests the sequence of functions of the second level and performs a setpoint/actual comparison of the variables to be controlled, the comparison of the setpoint engine torque with the actual engine torque, for example. The setpoint/actual comparison is performed in the second level of the trans-controller software frame. The monitoring module is implemented in a control unit in which the capability of implementing the error response requested in the event of an error is provided.

In another advantageous method step, at least one communication component of the trans-controller software frame coordinates the communication between the individual control units. In this case, the communication component inputs all monitoring variables coming from the bus system which are relevant for the respective control unit and makes them available to ail modules and components of the second level. These include the variables of the actual function monitoring, as well as the error response requests from other control units. Furthermore, the communication component is responsible for providing the variables to be sent outside, as well as error response requests to other control units. These include, in addition to the function variables, the error response requests from the respective control unit. By forwarding and receiving level 2-relevant variables and error response requests, communication between the individual control units is efficiently coordinated.

At least one error response handler of the trans-controller software frame advantageously coordinates the error response requests between the control units and implements them in a vehicle by activating appropriate actuators such as injectors, throttle valve, camshaft controller, or ignition coil. The internal and external error response requests are coordinated and implemented by an error response handler. For the respective control unit a matrix is produced showing which actuators may implement which error response requests and how the control response is to be selected to achieve the desired error response (for example, injector activation time=0 for internal engine torque=0). The error response handler controls the individual actuators according to the previously produced matrix.

It is furthermore advantageous if the error response handler of the trans-controller software frame performs error response monitoring wherein a requested response of an actuator is compared to the actual response of the actuator. If the error response monitoring determines that an error response has not been implemented, it addresses the local shut-off path and shuts off the control unit.

In an advantageous method step, at least one question-answer communication component of the trans-controller software frame performs question-answer communication between the exchangeable monitoring modules, the communication component, the error response handler, and other components. This means that the question-answer component is responsible for question-answer communication with the monitoring modules of the second level and the remaining modules and components of the trans-controller software frame. This question-answer component encapsulates the hardware of the control unit in such a way that always the same questions are posed to the monitoring modules independently of the control unit, and the corresponding correct answers are always the same, independently of the control unit. This facilitates a free exchange of the monitoring modules.

Moreover, this question-answer component may be configured rather differently depending on the control unit hardware, from the simplest case in which question-answer communication is already implemented in the control unit and this component only represents the interface to the functions of the second level, to the case where the actual control unit monitoring is implemented by two computers and this component must simulate a question-answer communication. The question-answer communication causes any errors to result in the respective control unit being reset to zero or shut off. The question-answer communication may be performed by a monitoring module (ASIC) or by a second computer.

The question-answer component of the trans-controller software frame advantageously controls the program sequence and, if an error is detected, shuts off the control unit or resets the function variables of the second level to zero.

At least one test component monitors the memory areas used by the modules or components of the second level and requests an error response if an error is detected. The memory areas used may be monitored cyclically.

The trans-controller software frame inputs, preferably via the communication component, the error responses and function variables of other control units which have been sent via the bus system; the communication component makes them available to the remaining modules and components of the trans-controller software frame and forwards them to other control units via the bus system after checking. This makes optimum communication between the individual control units possible.

Another advantage is if a watchdog is provided for monitoring the function of the computing elements of the individual control units, which checks the operation of the computing elements and that of the monitoring, using question-answer communication.

Furthermore advantageous is a trans-controller software frame for carrying out the method according to the previously described steps, which is implementable in a control unit, in particular in the computing unit of a control unit. The trans-controller software frame has a modular structure and at least one exchangeable monitoring module and advantageously at least one communication component, at least one error response handler, at least one test component, and/or at least one question-answer component. The monitoring modules of the second level may be variably introduced into and removed from the trans-controller software frame of a control unit. This makes it possible for a control unit to have a plurality of different monitoring modules and thus be able to respond to error response requests in a flexible manner. A control unit may cancel the error detected by another control unit without the other control unit having to cancel the error.

The monitoring concept and the trans-controller software frame are applicable in any technical system, in particular, however, in a vehicle.

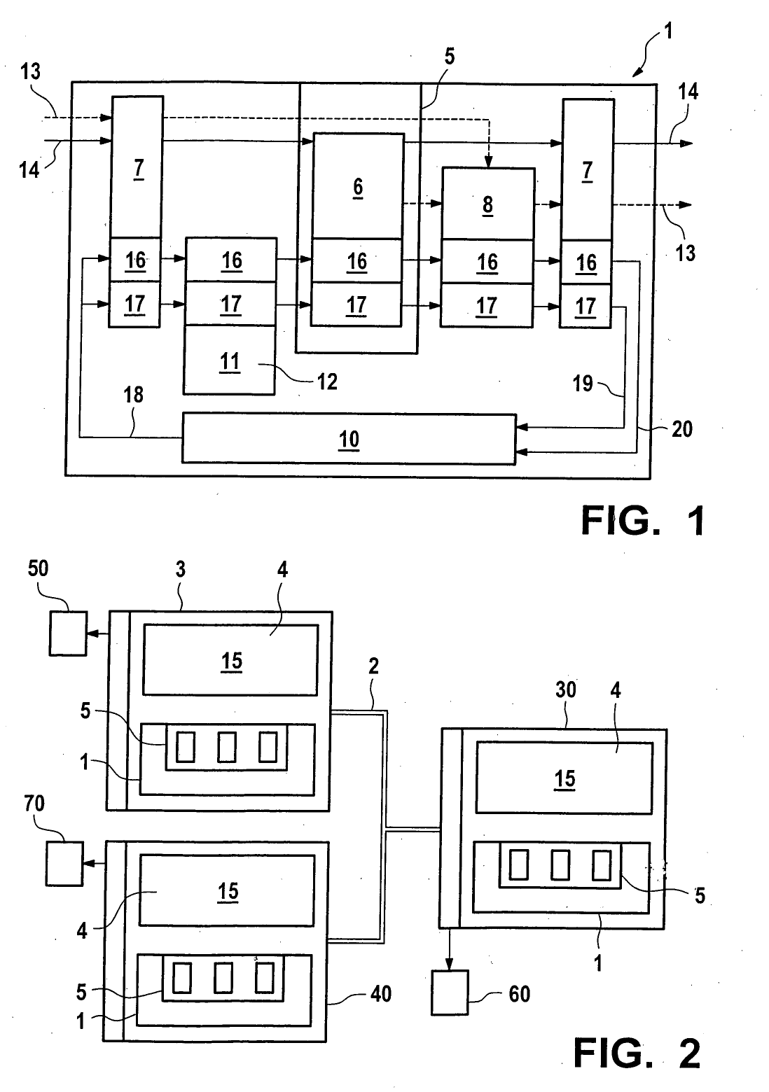

FIG. 1 shows a preferred embodiment of trans-controller software frame 1 and individual method steps which are performed by trans-controller software frame 1. Trans-controller software frame 1 is implemented in a control unit 3, 30, 40 and linked to the function software, i.e., user software 15 already present in control unit 3, 30, 40. Communication component 7 inputs all variables 13, 14 relevant for the second level and makes them available to local level 2 monitoring modules 6. Monitoring modules 6 are variably utilizable in trans-controller software frame 1. This means that not only monitoring module 6 of a corresponding control unit 3 may be used in trans-controller software frame 1, but also monitoring modules 6 which are responsible for other control units 30, 40. Monitoring modules 6 are freely distributable to all control units 3, 30, 40 connected to the network. Thus, the monitoring module responsible for the control unit of the accelerator pedal may also be used in the control unit responsible for the engine control and vice-versa.

The relevant variables which are made available to monitoring modules 6 are composed of function variables 14 of the actual monitoring and error response requests 13 by other control units 3, 30, 40. Communication component 7 of a control unit 3 in turn makes the relevant variables available to other control units 30, 40. These include, in addition to function variables 14, error response requests 13 from this control unit 3.

Error response handler 8 coordinates error response requests 13 which may be internal within the control unit or external. For this purpose, a matrix is produced for the respective control unit, which shows which actuators 9, such as accelerator pedal, injectors, or throttle valve, are capable of implementing which error response requests 13. Furthermore, error response handler 8 determines the control behavior for achieving the desired error response. Error response handler 8 activates the individual actuators 9 according to the optimum approach found. The actuators may be activated simultaneously or consecutively as required.

Error response handler 8 of trans-controller software frame 1 performs error response monitoring, a requested response of an actuator 9 being compared with the actual response of actuator 9. If the error response monitoring establishes that an error response 13 has not been implemented, it addresses the local shutoff path and shuts off control unit 3, 30, 40. Test component 11 monitors memory areas 12 used by monitoring modules 6, such as the RAM or the ROM. This monitoring is advantageously performed cyclically, but may also be performed in other ways.

Question-answer communication with monitoring modules 6 of second level 5 and with the modules and components 7, 8, 11 of trans-controller software frame 1 is conducted with the help of question-answer component 10. Question-answer component 10 poses internal questions 18 to the individual modules and components 6, 7, 8, 10 of trans-controller software frame 1. For this purpose, each monitoring module 6 and each component 7, 8, 11 has a program sequence controller 16. Furthermore, each monitoring module 6 and each component 7, 8, 11 has an instruction test component 17. A comparison is made in instruction test component 17 of a monitoring module 6 or another component 7, 8, 11 of trans-controller software frame 1 whether the actual response agrees with the requested response. This means that after internal question 18 passes through all modules and components, these return a response to question-answer component 10 regarding program sequence 19 and instruction test 20.

FIG. 2 shows a schematic illustration of a preferred monitoring concept for a vehicle having three control units 3, 30, 40. This means that FIG. 2 represents a possible application of the above-described monitoring concept involving three control units.

In this example, accelerator pedal module 50 is connected to control unit 3. Engine control module 60 is connected to control unit 30. Monitoring of accelerator pedal module 50 is to be implemented in control unit 3. The accelerator pedal position is transmitted via bus system 2 as a function variable of first level 4 and second level 5. Driver intent processing and engine control take place in control unit 30. If the component monitoring of accelerator pedal module 50 detects an accelerator pedal error, it requests an abstract error response such as, for example, an acceleration limitation or a maximum velocity limitation.

Error response request 13 is transmitted to control unit 30 of engine control module 60 by bus system 2. Control unit 3 is incapable of implementing this error response. To limit vehicle acceleration, either the engine torque may be reduced or brake intervention may be initiated. On the basis of the input data available, control unit 40 of brake pedal module 70 determines the safe longitudinal vehicle acceleration and makes it available to the other control units via bus system 2. Error response handler 8 of control unit 30 for engine control then reduces the engine torque. If this measure is insufficient, control unit 40 of brake pedal module 70 intervenes with active braking. Suitable calibration ensures that both measures support each other.

The above-described monitoring concept offers the advantage that a step-by-step implementation of this concept involves little modification of the existing systems.

1. A method for monitoring or regulating a technical system, having at least two control units (3, 30, 40) interconnected via a bus system (2), which have at least one computing element each and which perform monitoring-relevant control procedures and monitoring procedures, wherein a trans-controller software frame (1), which is implemented in the control units (3, 30, 40), monitors or regulates user software (15) of the control unit (3, 30, 40).

2. The method according to claim 1, wherein, after the implementation of the trans-controller software frame (1), in a computing element of a control unit (3, 30, 40), at least two independent levels (4, 5) are provided, the first level (4) performing the control function and a second level (5) performing the monitoring function.

3. The method according to claim 2, wherein, after the implementation of the trans-controller software frame (1), in the computing element of a control unit (3, 30, 40), a third level is provided which checks the operation of the computing element by monitoring the level (5) which performs the monitoring.

4. The method according to claim 1, wherein at least one monitoring module (level 2 module) (6), which is exchangeably connected to the second level (5) of the trans-controller software frame (1), tests the instruction set of the computing element's central processing unit (CPU) used by the same monitoring module.

5. The method according to claim 4, wherein the monitoring module (6) tests the sequence of functions of the second level (5) and performs a setpoint/actual comparison of the variable to be controlled.

6. The method according to claim 1, wherein at least one communication component (7) of the trans-controller software frame (1) coordinates communication between the individual control units (3, 30, 40).

7. The method according to claim 1, wherein at least one error response handler (8) of the trans-controller software frame (1) coordinates error response requests (13) between the control units (3, 30, 40) and implements them by activating respective actuators (9).

8. The method according to claim 7, wherein the error response handler (8) of the trans-controller software frame (1) performs error response monitoring, a requested response of an actuator (9) being compared with the actual response of the actuator (9).

9. The method according to claim 7, wherein the error response handler (8) shuts down the control unit (3, 30, 40) when an unimplemented error response is detected.

10. The method according to claim 7, wherein at least one question-answer component (10) of the trans-controller software frame (1) performs question-answer communication between the exchangeable monitoring modules (6), a communication component (7), and the error response handler (8).

11. The method according to claim 10, wherein the question-answer component (10) of the trans-controller software frame (1) controls the program sequence and, if an error is detected, shuts off the control unit (3, 30, 40) or sets function variables (14) of the second level (5) to zero.

12. The method according to claim 1, wherein at least one test component (11) monitors memory areas (12) used by modules and components (6, 7, 8) of the second level (5) and requests an error response (13) if an error is detected.

13. The method according to claim 6, wherein the communication component (7) of the trans-controller software frame (1) inputs error response requests (13) and function variables (14) of other control units (3, 30, 40) via a bus system (2), makes them available to modules and components (6, 7, 8) of the trans-controller software frame (1), and forwards them to other control units (3, 30, 40) via the bus system (2).

14. The method according to claim 1, wherein a watchdog is provided for monitoring the function of computing elements of the individual control units (3, 30, 40), which checks the operation of the computing elements and that of the monitoring, using question-answer communication.

15. A trans-controller software frame (1) for performing the method according to claim 1, which is implementable in a control unit (3, 30, 40), in particular in the computing element of a control unit (3, 30, 40).

16. The trans-controller software frame (1) according to claim 15, which has a modular structure and at least one exchangeable monitoring module (6).

17. The trans-controller software frame (1) according to claim 15, which has at least one communication component (7), at least one error response handler (8), or at least one question-answer component (10).
